(19) United States
(12) Patent Application Publication
(10) Pub. No.: US 2023/0124175 A1
(43) Pub. Date: Apr. 20, 2023

(54) ANSWERING PLACE-SPECIFIC, TIME-LIMITED QUESTIONS

(71) Applicant: MapZap Inc., Hillsboro, OR (US)

(72) Inventors: Ameet Joshi, Seattle, WA (US); Mandar Joshi, Hillsboro, OR (US); Swapnil Bawaskar, Bethany, OR (US)

(21) Appl. No.: 17/964,777

(22) Filed: Oct. 12, 2022

Related U.S. Application Data
(60) Provisional application No. 63/256,990, filed on Oct. 18, 2021.

(51) Int. Cl. H04L 51/222; H04L 51/046; H04W 4/029

(52) U.S. Cl. CPC H04L 51/222; H04L 51/046; H04W 4/029

(57) ABSTRACT

A facility is described that receives from a first user data specifying a question, a geographic location, and a time period. The facility receives an answer to the specified question from a second user at a time. The facility determines a geographic location of the second user at the time. The facility presents the received answer to the first user only if the time is during the time period and the determined geographic location is within a threshold distance of the specified geographic location.

### CROSS REFERENCE TO RELATED APPLICATIONS

This Application claims the benefit of provisional U.S. Application No. 63/256,990, filed Oct. 18, 2021, and entitled “ANSWERING PLACE-SPECIFIC, TIME-LIMITED QUESTIONS”, which is hereby incorporated by reference in its entirety. In cases where the present application conflicts with a document incorporated by reference, the present application controls.

### BACKGROUND

Smartphone apps enable users to perform a variety of useful functions using a device that is convenient to keep with them throughout various activities, across a variety of settings.

Mapping smartphone apps permit users to interact with maps. The maps displayed by mapping apps contain a variety of different visual information, including aerial images showing natural and manmade structures and textures, roads, political boundaries, points of interest, etc. It is common for users to be able to “pan” a map—scroll it to show an adjacent area at the same level of magnification—or “zoom” it to increase or decrease the magnification level. A user can also choose to display the map centered on their current location, determined via GPS, for example.

### BRIEF DESCRIPTION OF THE DRAWINGS

FIG. 1 is a block diagram showing some of the components typically incorporated in at least some of the computer systems and other devices on which the facility operates.

FIG. 2 is a flow diagram showing a process performed by the facility in some embodiments to enable a user to pose a question.

FIG. 3 is a display diagram showing a sample display presented by the facility in some embodiments to solicit the information needed to pose a question.

FIG. 4 is a display diagram showing a sample display presented by the facility in some embodiments in order to confirm creation of the question.

FIGS. 5A and 5B show a flow diagram showing a process performed by the facility in some embodiments in order to obtain answers to questions created by the facility.

FIG. 6 is a display diagram showing a sample display presented by the facility in some embodiments to solicit a location selection and a question selection.

FIG. 7 is a display diagram showing a sample display presented by the facility in some embodiments to solicit an answer to the question.

FIG. 8 is a display diagram showing a sample display presented by the facility in some embodiments to notify the question user that an answer to the question user’s question has been received.

FIG. 9 is a display diagram showing a sample display presented by the facility in some embodiments in order to display a list of answers received for a posed question at a first time.

FIG. 10 is a display diagram showing a sample display presented by the facility in some embodiments to show the answers received for a posed question at a second time after the first time.

FIG. 11 is a display diagram showing a sample display presented by the facility in some embodiments to convey analytic information to an advertiser about presentations of the advertiser’s advertising message, including information about the user to whom it was presented, and the actions they subsequently took, such as visiting the advertiser’s store or other location.

### DETAILED DESCRIPTION

The inventors have determined that it would be helpful to be able to pose real-time and near-real-time questions about geographic locations displayed in a mapping smartphone app.

In response to this recognition, the inventors have conceived and reduced to practice a software and/or hardware facility for answering place-specific, time-limited questions (“the facility”).

Users of a mobile app can pose time-limited questions about particular geographic locations. For example, a first user (the “questioning user”) could select a group of tennis courts on a map, and request a response in the next 10 minutes about whether any of the courts are free. Or the first user could request a response in the next 20 minutes about the wait time for a table at a particular restaurant. Other users can respond to these questions only if the GPS-determined location of their phones shows them to be at the specified locations. In some cases, a questioning user can price their questions in a special currency (e.g., “kudos”), making it more likely that their question will be answered by establishing higher prices. Those answering the question (“answering users”) receive the price amount from the requester, and can use this currency to ask their own questions.

In some cases, merchants can purchase advertising subscriptions to show limited-time ads to users while they are nearby the merchant’s geographic location. The app reports on the number of people who visit the merchant’s geographic location after seeing an ad. In some cases, the visitors are rewarded with currency that they can use to pose questions. In some cases, a merchant whose ad produces a significant number of visitors receives currency that it can use to purchase additional ads, extend the reach of its existing ads, receive additional analytics about the impact of its ads, etc.

By performing in some or all of the ways described above, the facility facilitates the answering of place-specific, time limited questions by people who are situated to give good answers. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks.

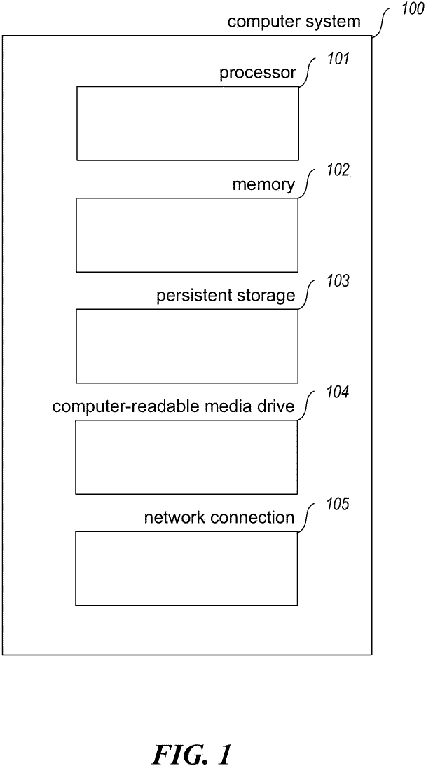

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

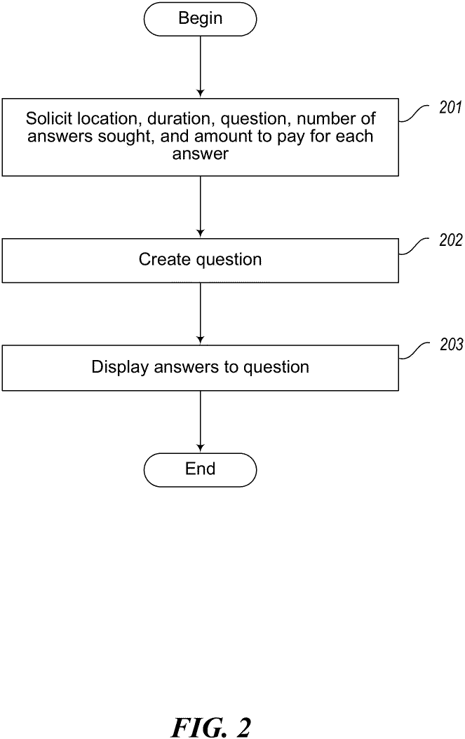

FIG. 2 is a flow diagram showing a process performed by the facility in some embodiments to enable a user to pose a question. In act 201, the facility solicits from the questioning user information needed to pose the question. In some embodiments, this involves a geographic location to which the question relates, a duration specifying how long answering users will be permitted to answer the question, the content of the question—such as in text, the number of answers (“flicks”) sought by the questioning user, and an amount to pay for each answer, such as in a special currency called “kudos.”

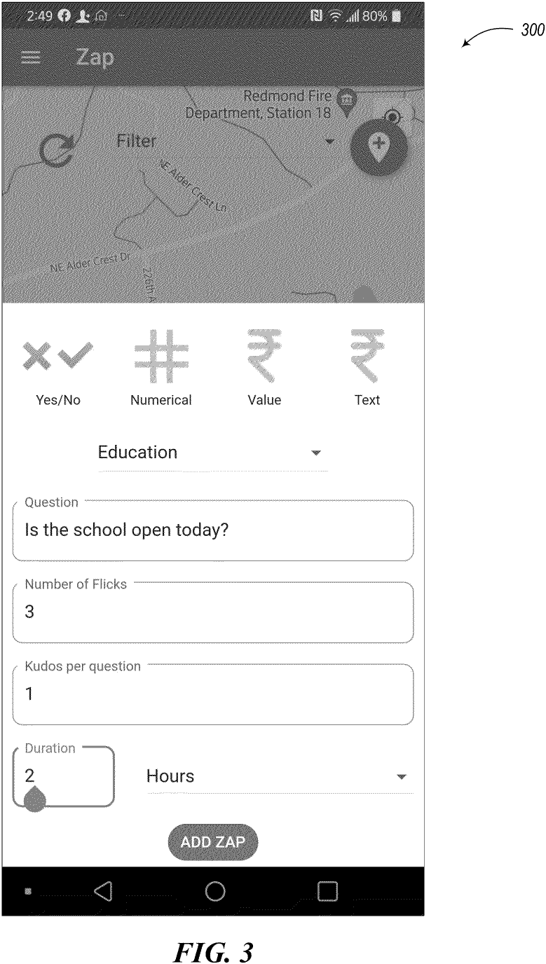

FIG. 3 is a display diagram showing a sample display presented by the facility in some embodiments to solicit the information needed to pose a question. It can be seen in display 300 that the questioning user specifies a location on a map; specifies a type of answer being sought (“yes/no,” “numerical,” “value,” or “text”); category of question (“education,” among others); question content (“Is the school open today?”); number of answers to the question being sought (3); amount in a special currency to be paid to each answering user (1 kudo); and duration (2 hours). The user can select an “add zap” control in order to create the question.

While FIG. 3 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

Returning to FIG. 2, in act 202, the facility creates the question based upon the information obtained in act 201.

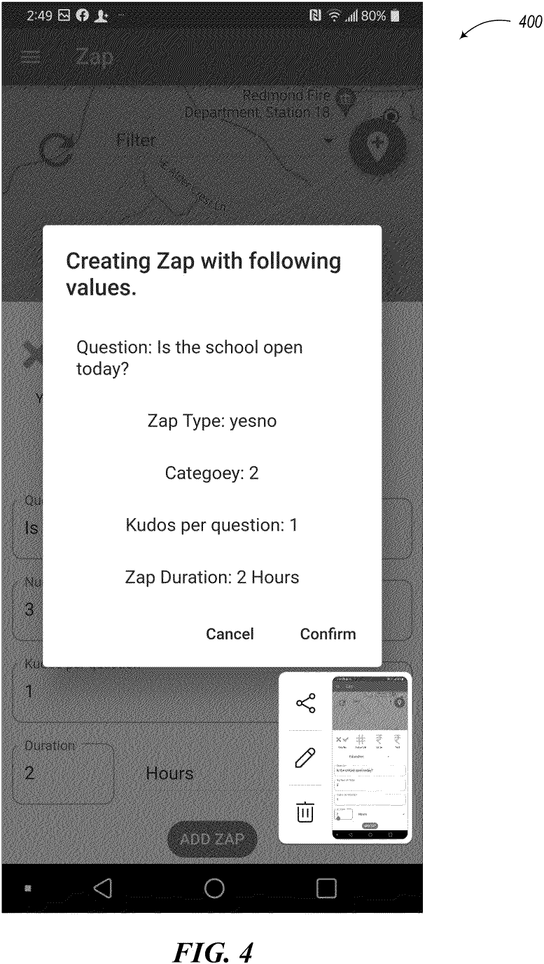

FIG. 4 is a display diagram showing a sample display presented by the facility in some embodiments in order to confirm creation of the question. In the display 400, the facility presents the information about the question provided by the user, and includes a “confirm” control that user can activate in order to complete creation of the question. Once the facility creates the question, it is available for users to discover, particularly during the time of its duration and in locations nearby to its geographic location.

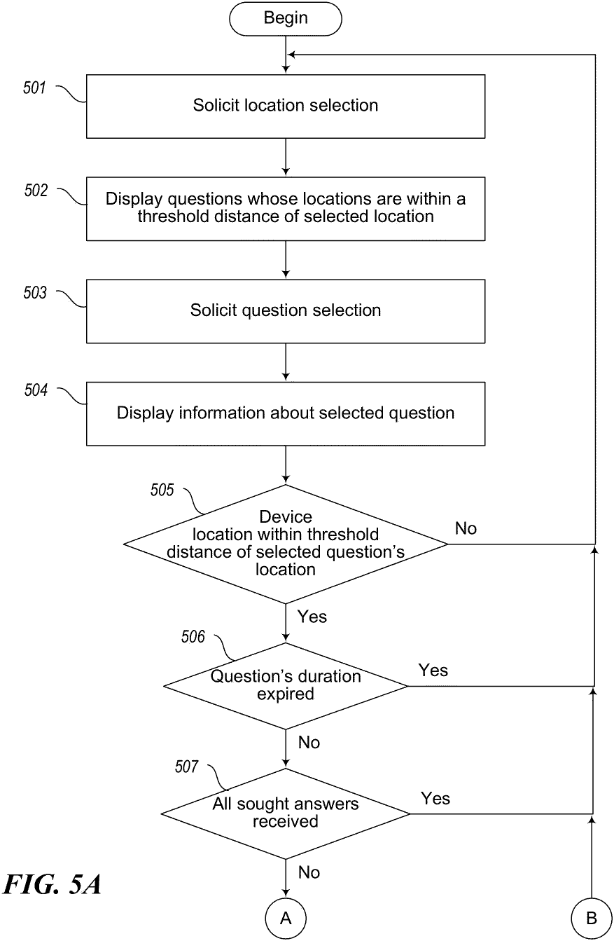

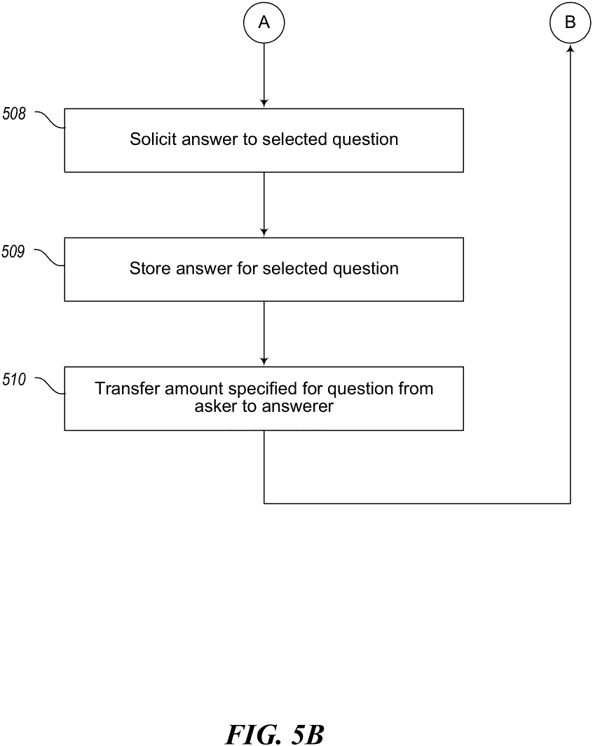

FIGS. 5A and 5B show a flow diagram showing a process performed by the facility in some embodiments in order to obtain answers to questions created by the facility. In act 501, the facility solicits the selection of a geographic location from an answering user. In various embodiments, this can involve: prompting the user to type the name or address of a particular location, or select a particular location on a map displayed to the user; and/or automatically selecting the user’s present location based on GPS or other location-sensing information generated by the user’s mobile device. In act 502, the facility displays questions whose locations are within a threshold distance of the location selected in act 501. In act 503, the facility solicits the selection of a question by the answering users. In act 504, the facility displays information about the selected question.

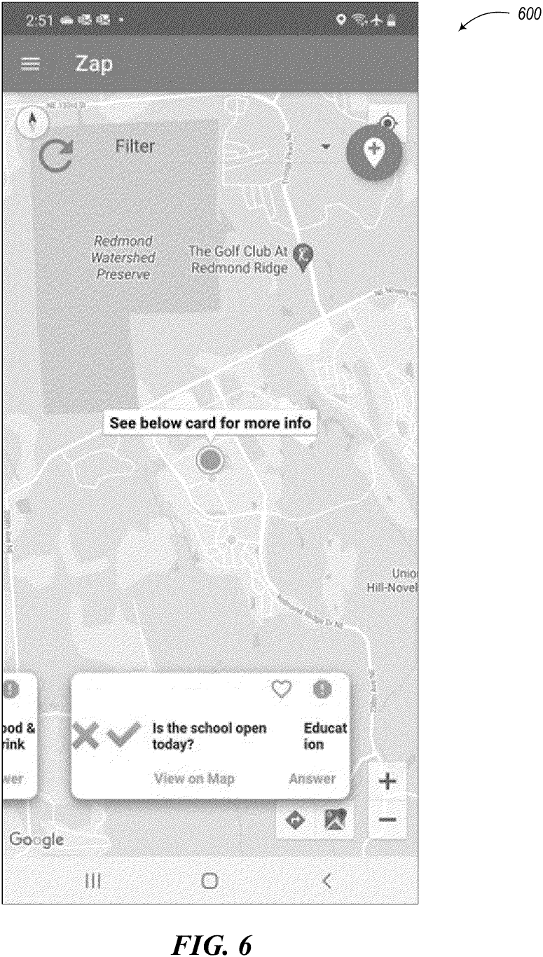

FIG. 6 is a display diagram showing a sample display presented by the facility in some embodiments to solicit a location selection and a question selection. In the display 600, the facility displays a map, which the user can pan and zoom using conventional interactions. The user can also activate a “show my location” control to select their present location and center it in the map. In response to location selection, the facility displays a location of a question in an orange circle, together with additional information about the question in a white rectangle below: additional information indicates that the question has a yes or no answer, and is “Is the school open today?”. This rectangle also includes a heart control to love or like the question, or save it as a favorite, and a reporting control to report that the question is improper. The rectangle also includes the category of the question, and controls to locate the question on the map if it is not presently displayed, or to answer the question.

Returning to FIG. 5, in act 505, if the device is within a threshold distance of the selected question’s location, then the facility continues in act 506, else the facility continues in act 501 to again solicit the selection of a location. In act 506, if the question’s duration has expired, then the facility continues in act 501, else the facility continues 507. In act 507, if all of the answers sought by the question user have been received, then the facility continues in act 501, else the facility continues through connector A to act 508. In act 508, the facility solicits an answer to the selected question from the questioning user.

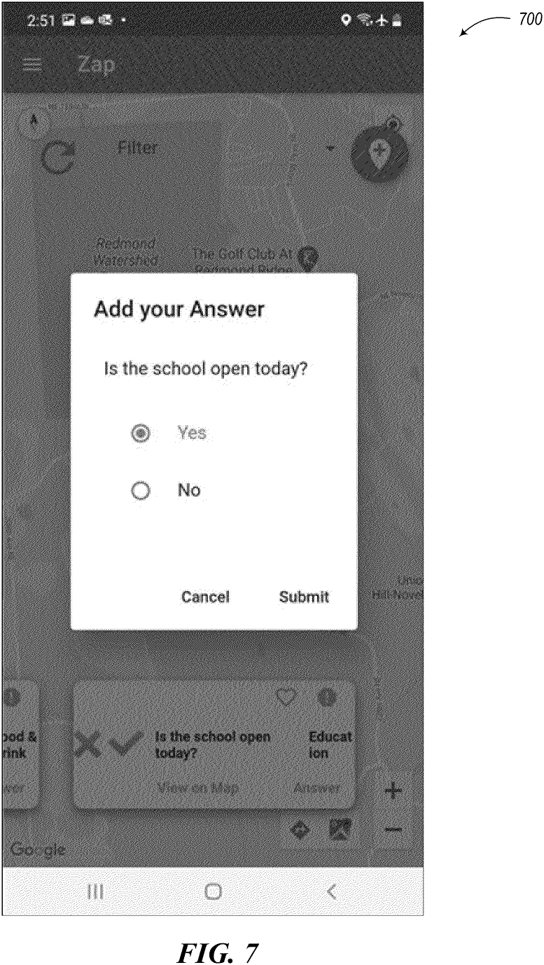

FIG. 7 is a display diagram showing a sample display presented by the facility in some embodiments to solicit an answer to the question. In the display 700, the facility redisplays the text of the question (“Is the school open today?”), and also a control for specifying the answer to the question, in this case “yes,” The display also includes a submit control that the user can activate in order to submit the answer that they specify.

Returning to FIG. 5, in act 509, the facility stores the answer to the selected question obtained in act 508. In act 510, the facility transfers the amount of currency specified for the question from its asker to its answerer. After act 510, the facility continues through connector B to act 501.

Those skilled in the art will appreciate that the acts shown in FIG. 5 and in each of the other flow diagrams discussed herein may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

Returning to FIG. 2, in act 203, the facility displays to the questioning user answers received from other users to the question posed by the questioning user. In various embodiments, other users can also view the answers provided to posed questions. After act 203, the process shown in FIG. 2 concludes.

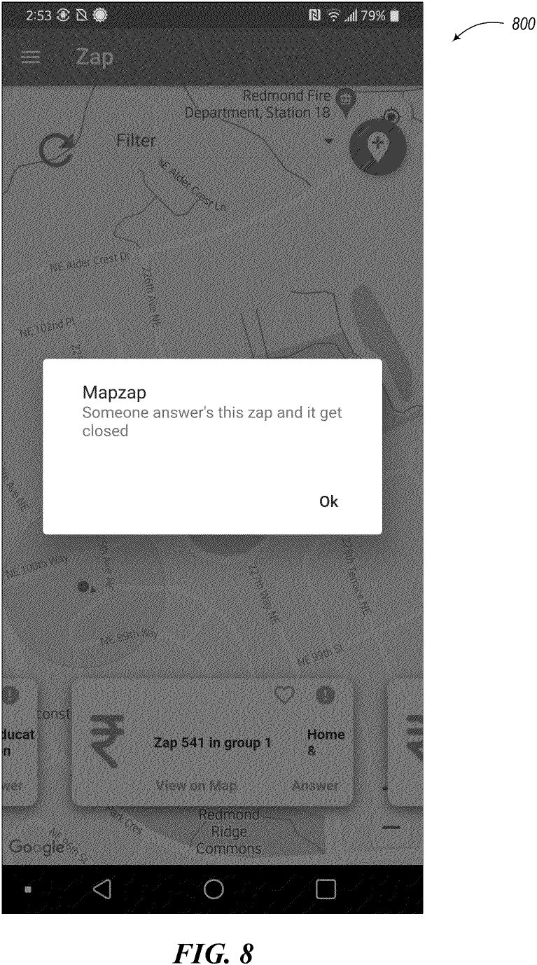

FIG. 8 is a display diagram showing a sample display presented by the facility in some embodiments to notify the question user that an answer to the question user’s question has been received. Such a notification can be seen in display 800.

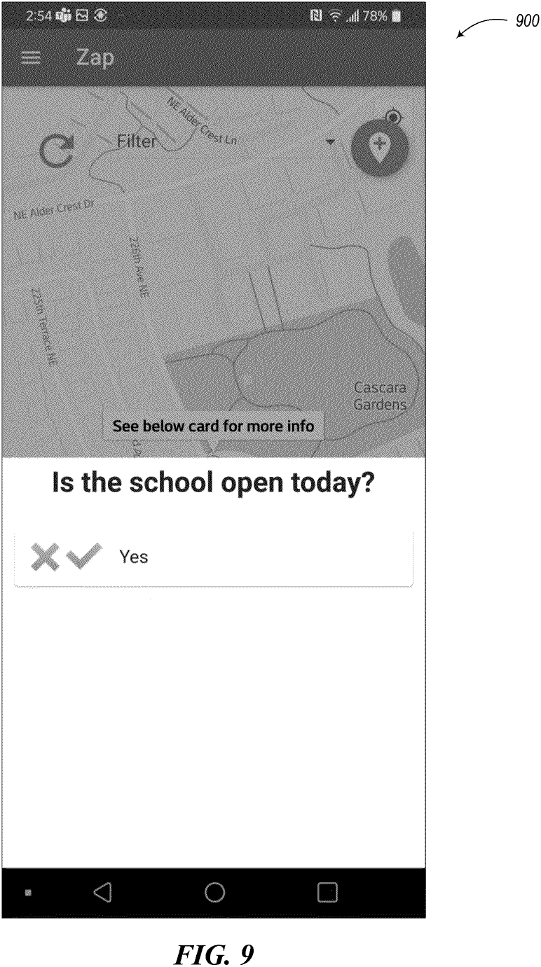

FIG. 9 is a display diagram showing a sample display presented by the facility in some embodiments in order to display a list of answers received for a posed question at a first time. In the display 900, it can be seen that the facility is displaying the answer whose provision by an answering user is shown in FIG. 7, a “yes” answer. As time progresses, additional answers to a question may be received, and these are shown by the facility as they are received.

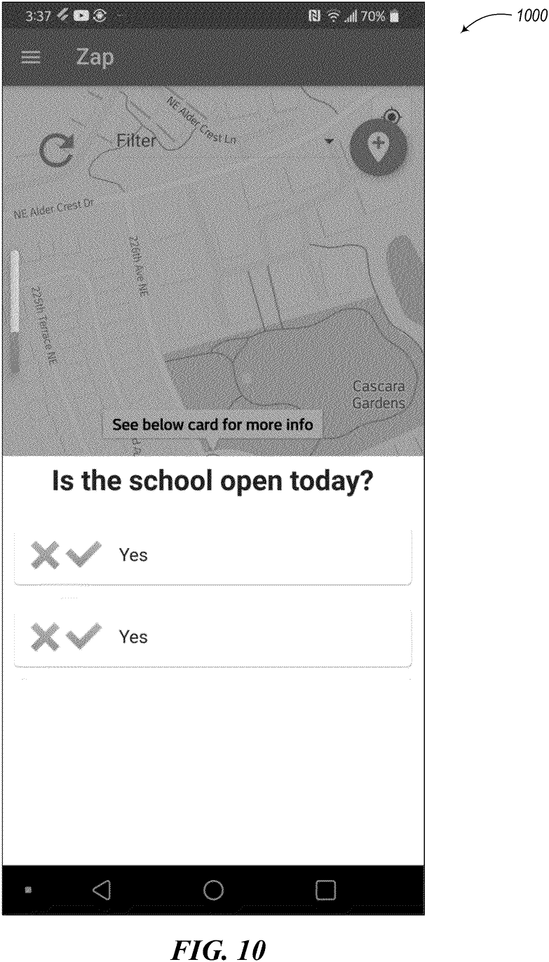

FIG. 10 is a display diagram showing a sample display presented by the facility in some embodiments to show the answers received for a posed question at a second time after the first time. It can be seen in display 1000 that the facility has received a second answer to the question posed in FIGS. 3 and 4, and that it, like the first answer, is also a “yes” answer.

In some embodiments, the facility provides analytics to advertisers whose advertising messages the facility presents to users of its smartphone app. In some embodiments, ads are targeted based upon day of week, time of day, date, present geographic location of the user based upon their mobile device’s reporting of physical location, demographics, explicitly and implicitly expressed interests, etc.

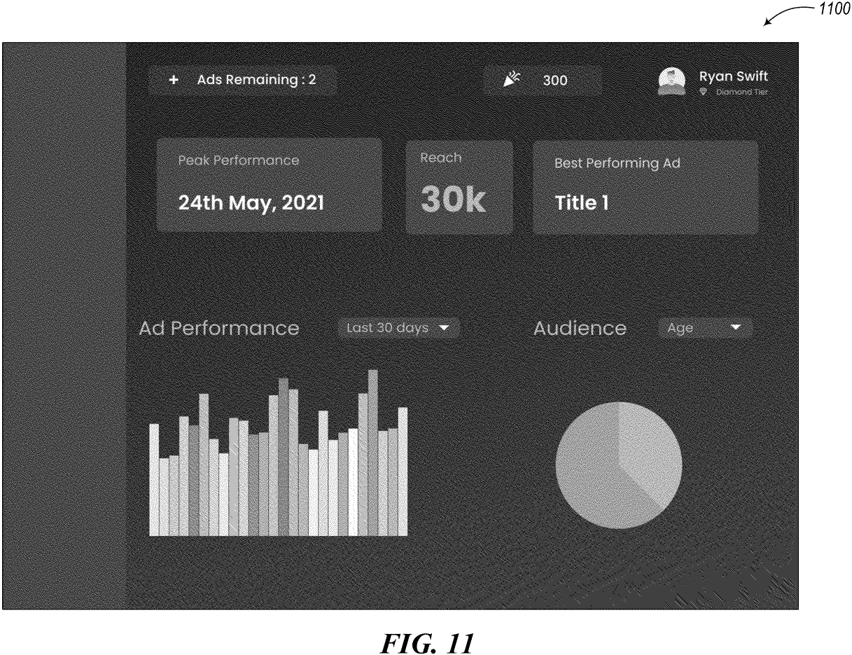

FIG. 11 is a display diagram showing a sample display presented by the facility in some embodiments to convey analytic information to an advertiser about presentations of the advertiser’s advertising message, including information about the user to whom it was presented, and the actions they subsequently took, such as visiting the advertiser’s store or other location. The display 1100 includes an indication of the number of ads that the merchant has paid for and not yet flighted; an indication of the amount of advertiser currency available to the advertiser; identifying information for the advertiser (“Ryan Swift”), an advertiser tier of the advertiser (“Diamond Tier); a peak performance date; a reach level; an indication of best performing ad; a historical view of ad performance whose scope is adjustable; and a characterization of the audience to whom the advertising message was presented, such as based upon demographic or behavioral information of those users (a pie graph showing the age breakdown of these users is shown). Those skilled in the art will appreciate that a variety of other advertising analytic measures can be included in such a display.

In various embodiments, the facility represents its state in a variety of ways, in some cases in accordance with the data storage schemes that follow.

Table 1

```
Consumer Schema
‘User’
  ‘password’
  ‘last_login’
  ‘is_superuser’
  ‘id’
  ‘is_active’
  ‘created_at’
  ‘modified_at’
  ‘phone’
  ‘name’
  ‘datejoined’
  ‘is_staff’
  ‘groups’
  ‘user_permissions’
‘Answer’
  ‘id’
  ‘answer’
  ‘correctness_score’
  ‘point’
  ‘location’
  ‘created_at’
  ‘modified_at’
‘Category’,
  ‘id’
  ‘title’
  ‘description’
  ‘path’
  ‘created_at’
  ‘modified_at’
‘Location’,
  ‘id’
  ‘location’
  ‘created_at’
  ‘modified_at’
  ‘user’
‘Otp’,
  ‘id’
  ‘is_active’
  ‘created_at’
  ‘modified_at’
  ‘phone’
  ‘otp’
  ‘count’
‘Zap’,
  ‘id’
  ‘name’
  ‘description’
  ‘cost’
  ‘zap_type’
  ‘answer’
  ‘response_count’
  ‘response_time’
  ‘location’
  ‘user_location’
  ‘is_active’
  ‘is_block’
  ‘is_disable’
  ‘is_deleted’
  ‘created_at’
  ‘modified_at’
  ‘user’
‘ZapHistory’,
‘ id’
  ‘name’
  ‘description’
  ‘zap_type’
  ‘location’
  ‘created_at’
  ‘parent_zap’
‘UserMeta’,
  ‘id’
  ‘trust_score’
  ‘points’
  ‘referral_code’
  ‘created_at’
  ‘modified_at’
  ‘user’
‘Statement’,
  ‘id’
  ‘point’
  ‘type’
  ‘reference’
  ‘reference_id’
  ‘created_at’
  ‘modified_at’
  ‘user’
  ‘Report’,
  ‘id’
  ‘reason’
  ‘created_at’
  ‘modified_at’
  ‘zap’
‘Referral’,
  ‘id’
  ‘is_active’
  ‘created_at’
  ‘modified_at’
  ‘referred_user’
  ‘user’
‘Notification’,
  ‘id’
  ‘type’
  ‘message’
  ‘data’
  ‘created_at’
  ‘modified_at’
  ‘user’
‘LocationHistory’,
  ‘id’
  ‘location’
  ‘created_at’
  ‘parent_location’
  ‘Interest’,
  ‘id’
  ‘status’
  ‘created_at’
  ‘modified_at’
  ‘category’
  ‘user’
‘Follow’,
  ‘id’
  ‘status’
  ‘cost’
  ‘created_at’
  ‘modified_at’
  ‘user’
  ‘zap’
‘AnswerHistory’,
  ‘id’
  ‘answer’
  ‘correctness_score’
  ‘point’
  ‘location’
  ‘created_at’
  ‘parent_answer’
```

Table 2

```
Merchant Schema
Business
  Name
  Address
  Lat, long
  Phone number
  Auto Id (primary key)
  Category Id (Foreign key)
  Subscription tier
  Hours of operation
  Score
  Payment method
Category
  Id
  Name
  Description
Users
  Name
  Email Add (primary)
  Contact num
  Privilege (Admin, Read only)
  Business Id (foreign key)
Transactions
  Transaction date
  Method of payment
  User who initiated the transaction/subscription based trigger (foreign key)
  Business Id (foreign key)
  Transaction Id (primary key)
Subscription History
  Business Id (fk)
  User id (fk)
  Old subscription tier
  New subscription tier
  Timestamp
Ad history
  Business Id (fk)
  Ads Redeemed
  Timestamp
Ads
Ad Id (pk)
  Image (file < 5MB)
  Business Id (fk)
  Description
  Title
  Views
CTA
  Likes
  Created At (timestamp)
Ads Schedule
  Schedule Id (pk)
  Business Id (fk)
  Campaign From
  Campaign to
  AD ID (fk)
  Created At (timestamp)
Inventory
  Inventory Id (pk)
  Business Id (fk)
  Image
  Desc
  Title
  Created at
```

The various embodiments described above can be combined to provide further embodiments. All of the U.S. Patents, U.S. Patent Application Publications, U.S. Patent Applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system, comprising:
receiving from a first user data specifying a question, a geographic location, and a time period;
receiving an answer to the specified question from a second user at a time;
determining a geographic location of the second user at the time; and
presenting the received answer to the first user only if the time is during the time period and the determined geographic location is within a threshold distance of the specified geographic location.
